(19) United States
(12) Patent Application Publication
(10) Pub. No.: US 2012/0131586 A1
(43) Pub. Date: May 24, 2012

(54) APPARATUS AND METHOD FOR CONTROLLING RESPONSE TIME OF APPLICATION PROGRAM

(75) Inventors: Woo Chul KANG, Daejeon (KR); Won Tae KIM, Chungcheongnam-do (KR); Seung Min PARK, Daejeon (KR); Soo Hyung LEE, Daejeon (KR); Kyung Il KIM, Daejeon (KR)

(73) Assignee: Electronics and Telecommunications Research Institute, Daejeon (KR)

(21) Appl. No.: 13/211,787

(22) Filed: Aug. 17, 2011

(30) Foreign Application Priority Data
Nov. 18, 2010 (KR) 10-2010-0115188

(51) Int. Cl. G06F 9/46

(52) U.S. Cl. 718/102

(57) ABSTRACT

The present invention relates to a multi-control method for management of the response time of a data-centric real-time application program. The present invention integrally models a first system for controlling the response time of CPU operations and a second system for controlling the response time of accessing a storage medium using a MIMO structure and simultaneously controls the response time of the CPU operation and the response time of accessing the storage medium through the configuration by the integrated modeling. According to exemplary embodiments of the present invention, it is possible to more efficiently control the response time than an existing feedback control method.

### RELATED APPLICATIONS

The present application claims priority to, and the benefit of, Korean Patent Application Serial Number 10-2010-0115188, filed on Nov. 18, 2010, the content of which is hereby incorporated by reference.

### BACKGROUND OF THE INVENTION

1. Field of the Invention

The present invention relates to an apparatus and a method for controlling the response time of an application program, and more particularly, to an apparatus and a method for controlling the response time of a data-centric real-time application program.

2. Description of the Related Art

Presently, the tasks of most of the real-time application programs executed in computers have a structure of transmitting results to a user within a time targeted by the user while periodically being executed. A target response time is tacitly expected at task execution periods or designated by a user.

There are two methods for enabling such periodic real-time tasks to satisfy a target time. The first method is to previously calculate whether all executions meet a target response time considering executaion periods between tasks and the worst execution time or the like and only when executions are proven possible, to actually perform execution in a computer. The second method is to periodically examine the response times of real-time tasks during execution, to compare it with a target response time targeted by a user and to reduce the difference with the target value through control. This method is generally defined as a method using feedback control.

Meanwhile, the feedback control method for existing real-time applications controls the response time by assigning only single type of resources, that is, CPU resources. This method is an efficient method when the response times of the real-time tasks are mainly dependent on only the CPU resources. In other words, when real-time tasks execute computing jobs mainly using a CPU and do not execute jobs using a storage device, such as a hard disk or Flash memory, the amount of CPU resources determine the response time.

However, when the real-time tasks execute the computing jobs using the CPU and input/output to/from the storage device, the response time of the real-time tasks are influenced by the amount of CPU resources and storage device resources. For example, when jobs of reading or writing data on the storage device by the real-time tasks are delayed, the response time of the corresponding real-time tasks is delayed even though the CPU resources are sufficiently assigned. That is, the response time of the data-centric real-time application program is dependent on not only the CPU resources but also the storage device. Accordingly, when an existing feedback control method for controlling only the assignment of the CPU resources is used for the data-centric real-time application program, efficiency is considerably lowered upon control of the response time.

### SUMMARY OF THE INVENTION

The present invention has been made in an effort to provide an apparatus and a method for controlling the response time of an application program which controls assigning of not only the CPU resources but also other resources and control the response time of the data-centric real-time application program.

An exemplary embodiment of the present invention provides a method for controlling a response time of an application program, the method including: a task execution step of executing a task of processing data according to a predetermined first period; a response time calculation step of calculating a response time of the task in consideration of a first time taken for operation upon execution of the task and a second time taken for storage medium access upon execution of the task; a response time comparison step of comparing a mean value of the calculated response times and a predefined target response time; and a response time control step of controlling the response time of the task every predetermined second period when a time difference between the compared two values is larger than the predetermined reference value.

The response time control step may modify assignment of resources of a computer for executing the application program upon control of the response time.

The second period may be longer than the first period, and the response time calculation step respectively calculates a mean value of the first times and a mean value of the second times whenever the second period is reached.

The method may further include a target response time definition step of defining the target response time separately for the first time and the second time. More preferably, the method may further include a target response time re-definition step of modifying and re-defining the target response time based on results of control of the response times for the tasks. More preferably, the target response time definition step may include a total time setting step of setting a total time which is the sum of the first time and the second time; a statistic calculation step of calculating a statistic of the first times and a statistic of the second times by repeatedly performing the tasks; a ratio calculation step of calculating a first ratio of the first time to the second time and a second ratio of the second time to the first time using the calculated statistic of the first times and the calculated statistic of the second times; and a target time definition step of defining the target first time in consideration of the set total time and the first ratio and defining the target second time in consideration of the set total time and the second ratio.

The response time control step may control the response time of the task according to whether there is a correlation between the first time and the second time. More preferably, when there is no correlation between the first time and the second time, the response time control step may include a first time control step of controlling a first response time by forcing the mean value of the first times calculated in consideration of the CPU percentage used to be identical to the target first time; and a second time control step of controlling a second response time by forcing the mean value of the second times calculated in consideration of a probability that data to be processed is stored in a buffer related to the storage medium to be identical to a target second time, as a control step independently performed with respect to the first time control step. More preferably, when there is no correlation between the first time and the second time, the response time control step may include an integrated time control step of controlling the first response time by forcing the mean value of the first times calculated in consideration of the CPU percentage used to be identical to the target first time, while simultaneously forcing the mean value of the second values calculated in consideration of the probability that data to be processed is stored in the buffer related to the storage medium. More preferably, the first time control step may control the first response time by modeling the relationship between the CPU percentage used and the calculated mean value of the first times and the second time control step may control the second response time by modeling the relationship between the ratio used and the calculated mean value of the second times.

The task execution step may include a determination step of determining whether data to be processed is stored in a buffer related to the storage medium when data is processed by accessing a storage medium; a data reception step of receiving the stored data from the buffer when the data is stored in the buffer, and receiving corresponding data from the storage medium through the buffer when the data is not stored in the buffer; and a data processing step of processing the received data. More preferably, the task execution step may further include a buffer size alteration step of altering the cache size of the buffer when the data is not stored in the buffer.

Another exemplary embodiment of the present invention provides an apparatus for controlling a response time of an application program, the apparatus including: a task execution unit for executing a task of processing data according to a predetermined first period; a response time calculation unit for calculating a response time of the task in consideration of a first time taken for operation upon execution of the task and a second time taken for storage medium access upon execution of the task; a response time comparison unit for comparing a mean value of the calculated response times and a predefined target response time; and a response time control unit for controlling the response time of the task every predetermined second period when a time difference between the compared two values is larger than the predetermined reference value.

The response time control unit may modify assignment of resources of a computer for executing the application program upon control of the response time.

The second period is longer than the first period, and the response time calculation unit respectively calculates a mean value of the first times and a mean value of the second times whenever the second period is reached.

The apparatus may further include a target response time definition unit for defining the target response time separately for the first time and the second time. More preferably, the apparatus may further include a target response time re-definition unit for modifying and re-defining the target response time based on results of control of the response times for the tasks. More preferably, the target response time definition unit may include a total time setting unit for setting a total time which is the sum of the first time and the second time; a statistic calculation unit for calculating a statistic of the first times and a statistic of the second times by repeatedly performing the tasks; a ratio calculation unit for calculating a first ratio of the first time to the second time and a second ratio of the second time to the first time using the calculated statistic of the first times and the calculated statistic of the second times; and a target time definition unit for defining the target first time in consideration of the set total time and the first ratio and defining the target second time in consideration of the set total time and the second ratio.

The response time control unit may control the response time of the task according to whether there is a correlation between the first time and the second time. More preferably, when there is no correlation between the first time and the second time, the response time control unit may include a first time control unit for controlling a first response time by forcing the mean value of the first times calculated in consideration of the CPU percentage used to be identical to the target first time; and a second time control unit for, as a control step independently performed with respect to the first time control step, controlling a second response time by forcing the mean value of the second times calculated in consideration of a probability that data to be processed is stored in a buffer related to the storage medium to be identical to a target second time. More preferably, when there is no correlation between the first time and the second time, the response time control unit may include an integrated time control unit for controlling the first response time by forcing the mean value of the first times calculated in consideration of the CPU percentage used to be identical to the target first time, while simultaneously forcing the mean value of the second values calculated in consideration of the probability that data to be processed is stored in the buffer related to the storage medium. More preferably, the first time control units may control the first response time by modeling the relationship between the CPU percentage used and the calculated mean value of the first times and the second time control unit may control the second response time by modeling the relationship between the ratio used and the calculated mean value of the second times.

The task execution unit may include a determination unit for determining whether data to be processed is stored in a buffer related to the storage medium when data is processed by accessing a storage medium, a data reception unit for receiving the stored data from the buffer when the data is stored in the buffer, and receiving corresponding data from the storage medium through the buffer when the data is not stored in the buffer, and a data processing unit for processing the received data. More preferably, the task execution unit may further include a buffer size alteration unit for altering the cache size of the buffer when the data is not stored in the buffer.

The present invention controls the response time of a data-centric real-time application program assigning not only the CPU resources but also other resources, thereby obtaining the following advantages. Firstly, the response time is more efficiently controlled than an existing feedback control method. When tasks access data in a storage medium many times, the response time of the tasks are influenced by not only the response time taken for the operation in a CPU but also the response time taken to access the storage medium, thereby being affected by the sum of the response times. The present invention controls both the CPU response time and the response time for storage medium access since the present invention takes into account these problems, thereby providing efficient response time control. Secondly, a task response time desired by the user can be dynamically close to a mean task response time measured during the execution of a task. Thirdly, the response time of the task can be more finely and specifically measured than existing methods/systems by dividing the real-time of the task into the response time of the CPU operation and the response time of accessing the storage device, and providing mean response times respectively to target response times. Fourthly, an efficient response time can be provided by expressing the correlation between multi-inputs and multi-outputs and proposing a structure of simultaneously controlling multi-system inputs when the response time of the CPU operation and the response time of accessing the storage medium are highly related with each other.

### BRIEF DESCRIPTION OF THE DRAWINGS

FIG. 1 is a block diagram schematically showing an apparatus of controlling the response time of an application program according to an exemplary embodiment of the present invention;

FIG. 2 is a block diagram specifically showing the internal configuration of the apparatus for controlling the response time according to an exemplary embodiment of the present invention;

FIG. 3 is a diagram showing the general execution structure of the data-centric real-time tasks;

FIG. 4 is a diagram showing a procedure of accessing to a storage medium;

FIG. 5 is a diagram showing a first control method proposed by an exemplary embodiment of the present invention;

FIG. 6 is a diagram showing a second control method proposed by an exemplary embodiment of the present invention;

FIG. 7 is a flow chart showing a method of controlling the response time of an application program according to an exemplary embodiment of the present invention; and

FIG. 8 is an exemplary diagram showing an embodiment of a procedure of controlling a response time using a multi-control method.

### DETAILED DESCRIPTION OF THE EMBODIMENTS

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the exemplary embodiment of the present invention will be described, but it will be understood to those skilled in the art that the spirit and scope of the present invention are not limited thereto and various modifications and changes can be made.

The present invention relates to a multi-control method for management of the response time of a data-centric real-time application program, and is based on a method for periodically examining the response times of real-time tasks during execution, comparing it with a response time targeted by a user and reducing the difference with the target value through control, that is, a method using feedback control.

The present invention integrally models a first system for controlling the response time of CPU operations and a second system for controlling the response time of accessing a storage medium using a MIMO structure and simultaneously controls the response time of the CPU operation and the response time of accessing the storage medium through the configuration by the integrated modeling.

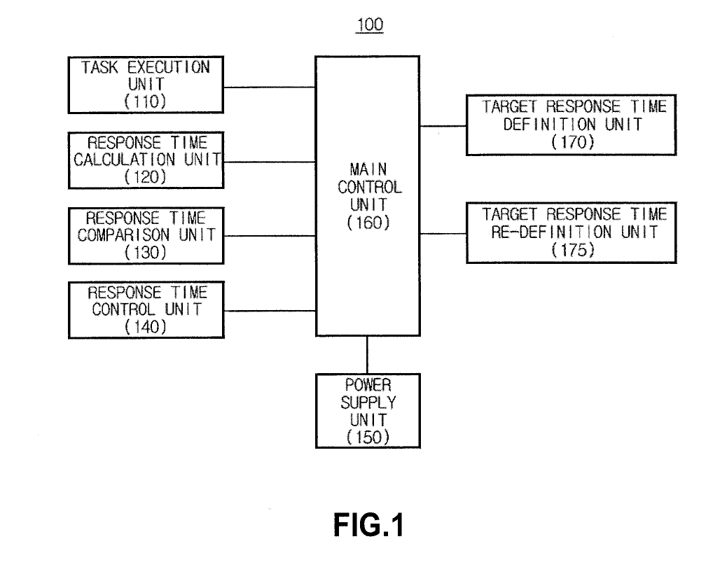

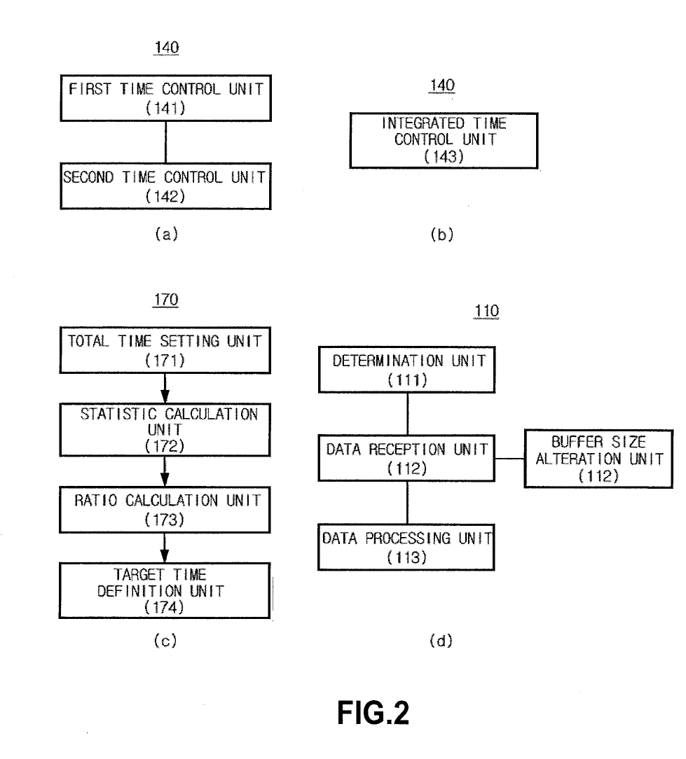

FIG. 1 is a block diagram schematically showing an apparatus of controlling the response time of an application program according to an exemplary embodiment of the present invention. FIG. 2 is a block diagram specifically showing the internal configuration of the apparatus for controlling the response time according to an exemplary embodiment of the present invention. The following description will be described with reference to FIGS. 1 and 2.

Referring to FIG. 1, the apparatus 100 for controlling the response time of an application program includes a task execution unit 110, a response time calculation unit 120, a response time comparison unit 130, a response time control unit 140, a power supply unit 150 and a main control unit 160.

In the exemplary embodiment, the apparatus 100 for controlling the response time of an application program is an apparatus for efficiently controlling the response time by simultaneously controlling other resources in addition to CPU resources in order to satisfy the response time targeted by a user using feedback control in a data-centric real-time application program.

The task execution unit 110 performs a function of executing tasks for processing data according to a predetermined first period.

The response time calculation unit 120 performs a function of calculating the response time of tasks in consideration of a first time taken for operation upon execution of the tasks and a second time taken for access to a storage medium upon execution of the tasks. Preferably, considering that a second period is longer than a first period, the response time calculation unit 120 performs a function of calculating the mean value of the first times and the mean value of the second times, respectively, whenever the second period is reached.

The response time comparison unit 130 performs a function of comparing the mean value of the calculated response times and a predefined target response time.

The response time control unit 140 performs a function of controlling the response time of tasks every predetermined second period when the time difference of the compared two values is larger than a predetermined reference value. In the exemplary embodiment, the response time control unit 140 may control the response time of the tasks when the compared two values are not identical to each other.

The response time control unit 140 modifies the assignment of computer resources which enable the application program to be executed upon control of the response time. In this case, the computer resources of which the assignment is modified are CPU resources, storage medium resources and the like.

The response time control unit 140 controls the response time of the tasks according to whether there is a correlation between the first time and the second time. In the exemplary embodiment, as an example in which there is a correlation, there is a phenomenon in which the CPU percentage used increases due to frequent updating of the buffer cache when the hit ratio of a buffer cache is low. When there is no correlation between the first time and the second time, the response time control unit 140 includes a first time control unit 141 and the second time control unit 142 as shown in FIG. 2A. The first time control unit 141 performs a function of controlling a first response time by forcing the mean value of the first times calculated in consideration of the CPU percentage used to be identical to the target first time. The second time control unit 142 performs a function of controlling a second response time by forcing the mean value of the second times calculated in consideration of a probability that data to be processed is stored in a buffer related to the storage medium to be identical to a target second time, as a control step independently performed with respect to the step of controlling the first time. On the other hand, when there is a correlation between the first time and the second time, the response time control unit 140 includes an integrated time control unit 143 as shown in FIG. 2B. The integrated time control unit 143 performs a function of controlling the first response time by forcing the mean value of the first times calculated in consideration of the CPU percentage used to be identical to the target first time while simultaneously controlling the second response time by forcing the mean value of the second values calculated in consideration of the probability that data to be processed is stored in the buffer related to the storage medium to be identical to the target second time.

In the exemplary embodiment, the first time control unit 141 controls the first response time by modeling a relationship between the CPU percent used and the calculated mean value of the first times. Furthermore, the second time control unit 142 controls the second response time by modeling a relationship between the probability that data to be processed has been stored and the mean value of the second times. The first time control unit 141 and the second time control unit 142 may use linear regression upon modeling. Meanwhile, the integrated time control unit 143 has a form in which the first time control unit 141 and the second time control unit 142 are integrated, thereby controlling the response time using the above-described modeling method.

The power supply unit 150 performs a function of supplying power to the respective units constituting the apparatus 100 for controlling the response time of an application program.

The main control unit 160 performs a function of controlling the overall operations of the respective units constituting the apparatus 100 for controlling the response time of an application program.

The apparatus 100 for controlling the response time of an application program may further include a target response time definition unit 170. The target response time definition unit 170 performs a function of defining target response times separately for the first time and the second time. In the exemplary embodiment, the target response time definition unit 170 may include a total time setting unit 171, a statistic calculation unit 172, a ratio calculation unit 173 and a target time definition unit 174 as shown in FIG. 2C. The total time setting unit 171 performs a function of setting a total time which is the sum of the first time and the second time. The statistic calculation unit 172 performs a function of calculating the statistic of the first times and the statistic of the second times by repeatedly performing the tasks. The statistic calculation unit 172 may calculate the mean values using the statistics. The ratio calculation unit 173 performs a function of calculating a first ratio of the first time to the second time and a second ratio of the second time to the first time using the calculated statistic of the first times and the calculated statistic of the second times. The target time definition unit 174 performs a function of defining the target first time in consideration of the set total time and the first ratio and defining the target second time in consideration of the set total time and the second ratio. Meanwhile, the apparatus 100 for controlling the response time of an application program may further include a target response time re-definition unit 175. The target response time re-definition unit 175 performs a function of modifying and re-defining the target response time based on the result of control of the response times for tasks.

Considering the case in which data is processed by accessing a storage medium, the task execution unit 110 may include a determination unit 111, a data reception unit 112, and a data processing unit 113 as shown in FIG. 2D. The determination unit 111 performs a function of determining whether data to be processed is stored in a buffer related to the storage medium. The data reception unit 112 performs a function of receiving the stored data from the buffer when the data is stored in the buffer, and receiving corresponding data from the storage medium through the buffer when the data is not stored in the buffer. The data processing unit 113 performs a function of processing the received data. Meanwhile, the task execution unit 110 may further include a buffer size alteration unit 114. The buffer size alteration unit 114 performs a function of altering the cache size of a buffer so as to satisfy a target hit ratio in response to a request from the response time control unit 140. An embodiment of the apparatus 100 for controlling the response time of an application program is described below.

The apparatus 100 for controlling the response time of an application program is an apparatus for automatically managing a response time requested by a data-centric teal-time application program using a multiple-control method. The apparatus 100 for controlling the response time of an application program adjusts the response time to be close to a target response time by modifying the assignment of CPU resources when the mean response time is different from the target response time. Various methods may be used to modify the assignment of the CPU resources. For example, the CPU resources may be additionally assigned to real-time tasks by lowering the number of data updates. This may result in an effect of shortening the response times of the real-time tasks.

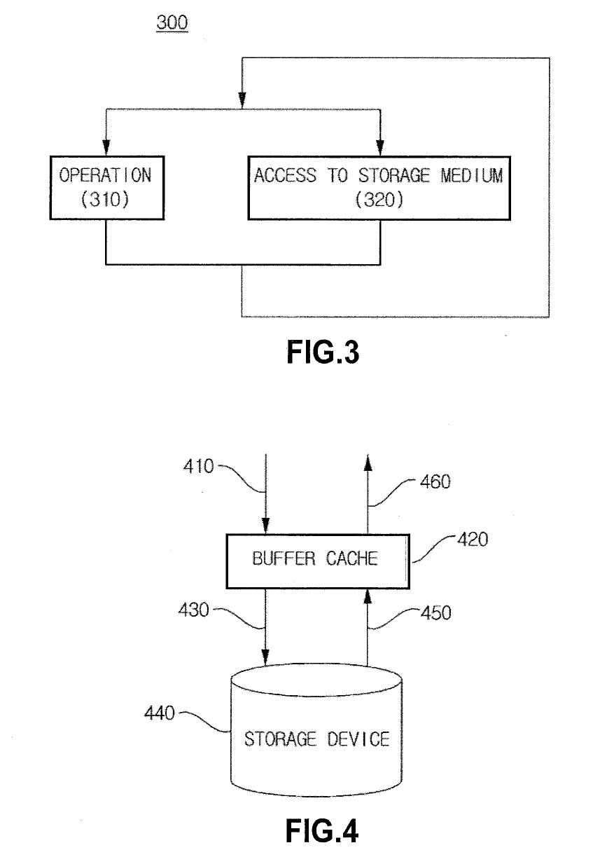

FIG. 3 shows the general execution structure of the data-centric real-time tasks. The data-centric real-time task 300 is composed of a job 310 which the CPU operates using data on a memory without accessing the storage medium and a job 320 for accessing the storage medium and then performing reading or writing. At any one time point, the task executes any one of the two jobs. One period of the data-centric real-time task is progressed such that an operation and an access to the storage medium are repeatedly performed. In the exemplary embodiment, the execution of the task is made by the task execution unit 110 of FIG. 1.

The response time of one task is represented as the sum of the total time taken for the operation and the total time taken for accessing the storage medium when the task is executed for one period. In the exemplary embodiment, the calculation of the response time is executed by the response time calculation unit 120 of FIG. 1. If the response time of a task during one period is designated by T, the total time taken for the operation is indicated as T_COMP, and the total time for accessing the storage medium is indicated as T-IO, the relationship therebetween may be established as follows:

T=T_COMP+T_{—}IO

As shown in this relationship, the response time of the task depends on both the time taken for the operation through the CPU and the time taken for accessing a storage device.

The access to the storage medium occurs through a process as shown in FIG. 4. In the exemplary embodiment, the access to the storage medium is executed by the task execution unit 110 of FIG. 1. An instruction 410 to access data within the storage device executed by the task passes through a buffer cache 420. The buffer cache is a temporary storage area in which parts of contents of the storage device 440 are stored. When the buffer cache has corresponding data, requested data is transmitted without accessing the storage device (460). In the exemplary embodiment, whether the data is stored in the buffer is determined by the determination unit 111 of FIG. 2. When the data is stored in the buffer, the data reception unit 112 of FIG. 2 receives the corresponding data from the buffer. When the data is not found in the buffer cache, access to the storage device is actually executed (430), the data of the storage device is first transmitted to the buffer cache (450), and the data is transmitted from the buffer cache to the task (460). When the data is not stored in the buffer, the function of receiving the corresponding data from the storage medium through the buffer is performed by the data reception unit 112 of FIG. 2. The ratio that the data is found in the buffer cache refers to a ‘hit ratio’. Generally, the hit ratio correspondingly increases as the size of the buffer cache increases. Accordingly, the size of the buffer cache is altered when the hit ratio is arbitrarily modified. In the exemplary embodiment, the buffer cache size alteration is performed by the buffer size alteration unit 114 of FIG. 2.

Control to a system is repeatedly performed at uniform periods which refers to a control period. The response time targeted for the task T_TARGET is designated by a user or an application program. In the exemplary embodiment, the target response time is designated by the total time setting unit 171 of FIG. 2. The period of a task during one control period is repeated several times, where the mean value of the response times T of a corresponding task observed during the control period is called T_AVG. This means that, as the mean value is closer to the target response time T_TARGET defined by a user, the real-time task is executed with higher predictability. If the mean value of the response times related to operations by the CPU among the response times of a task is indicated as T_AVG_COMP, and the mean value of the response times related to the operations for accessing the storage device is indicated as T_AVG_IO, the relationship therebetween is established as follows:

T_AVG=T_AVG_COMP+T_AVG_{—}IO

Each task is composed of the CPU operation and access to the storage device, so that an ideal ratio of the CPU operation and access the storage device may be derived during a corresponding task. That is, the hit ratio is 100%, T_AVG_IO denotes a time taken for accessing the buffer cache without accessing the storage device. For the CPU operation, when there is no simultaneously executed other tasks, the CPU is exclusively used, so that T_AVG_COMP denotes a minimum execution time required to execute a corresponding task. As described above, ideal response time for CPU operation and access to the storage device may be obtained by executing a task several times and calculating the statistic thereof. In the exemplary embodiment, calculation for the statistics is performed by the statistic calculation unit 172. When the ideal response times for two operations are indicated respectively as T_IDEAL_CPU and T_IDEAL_IO, the ratio between the two values is obtained as follows. In the exemplary embodiment, calculation for the ratio is performed by the ratio calculation unit 173.

RATIO_IDEAL_{—}CPU=T_IDEAL_{—}CPU/(T_IDEAL_{—}CPU+T_IDEAL+IO)

RATIO_IDEAL_{—}IO=T_IDEAL_{—}IO/(T_IDEAL_{—}CPU+T_IDEAL+IO)

For example, if T_IDEAL_CPU is 200 milliseconds, and T_IDEAL_IO is 200 milliseconds, RATIO_IDEAL_CPU=0.5 and RATIO_IDEAL_IC=0.5. Using the ratio between the two operations as obtained above, a target CPU operation response time, T_TARGET_CPU and a target storage medium access time T_TARGET_IO are calculated as follows. In the exemplary embodiment, the target CPU operation response time and the target storage medium access time are defined by the target time definition unit 174.

T_TARGET_{—}CPU=T_TARGET×RATIO_IDEAL_{—}CPU

T_TARGET_{—}IO=T_TARGET×RATIO_IDEAL_{—}IO

The sum of T_TARGET_CPU and T_TARGET_IO is identical to T_TARGET.

The real-times of the CPU operation and the access to the storage device during one period are calculated as follows.

TARDY_{—}CPU=T_AVG_{—}CPU/T_TARGET_{—}CPU

TARDY_{—}IO=T_AVG_{—}IO/T_TARGET_{—}IO

In the two relationship equations, the fact that TARDY_CPU and TARDY_IO are both close to number 1 means that the target response time is close to the current response time of the tasks. The main object of feedback control in the exemplary embodiment is to make the TARDY_CPU and TARDY_IO close to 1.

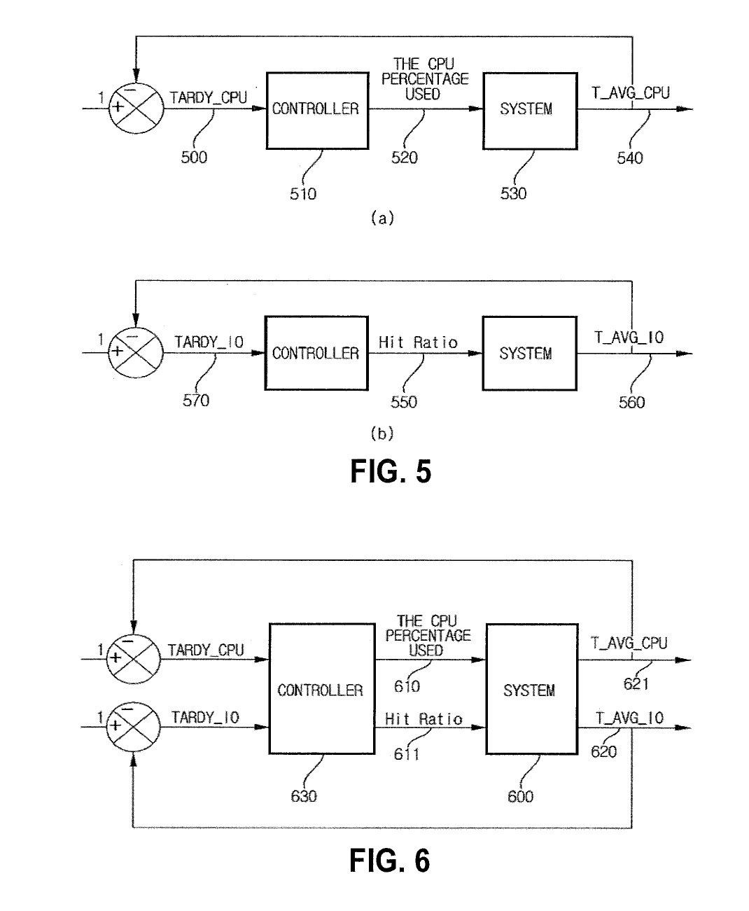

When there are two control parameters, TARDY_CPU and TARDY_IO, a first control method proposed by the exemplary embodiment is to meet a response time required by a system by manufacturing controllers separately for TARDY_CPU 500 and TARDY_IO as shown in FIGS. 5A and 5B. FIG. 5A is an example implementing the first time control unit 141, and FIG. 5B is an example implementing the second time control unit 142. A control procedure in FIG. 5A is described below. When there is a computing system 530 in which a task is executed, the relationship between a CPU percentage used 520 and T_AVG_CPU 540, which are control inputs, is experimentally obtained. The relationship experimentaly obtained is to model the relationship between two variables through repeated examinations using a method, such as linear regression. Herein, the CPU percentage used refers to an occupancy rate at which the CPU is used. When, a system is defined by the relationship between two variables as described above, a controller 510 is manufactured. In this case, a general controller, such as PID (Proportional Integral), may be used. When the system is modeled and the controller is manufactured as described above, the procedure of feedback control is performed at every control period.

As shown in FIG. 5B, a procedure of controlling the storage medium access response time is performed similarly to FIG. 5A. The difference therebetween is that a system is modeled based on the relationship between the hit ratio 550 of the buffer cache and T_AVG_IO 560. Two controllers which are independently operated, observe T_AVG_CPU 540 and T_AVG_IO 560, which are the respective outputs of the systems of interest and make TARDY_CPU 500 and TARDY_IO 570 close to 1.

As described above, a method for independently controlling the respective response times when using CPU resources and storage medium resources is efficient when the response time for CPU operations and the response time for access to a storage medium are not related with each other. However, when there is a correlation between the two response times, it is impossible to obtain an efficient control result when separates controllers are respectively used for the response time for CPU operations and the response time for access to a storage medium. For example, when the hit ratio of the buffer cache is low, a phenomenon that the CPU percentage used increases due to frequent updating of buffer cache. That is, the hit ratio is correlated with not only T_AVG_IO but also T_AVG_CPU. This is also applied to the relationship between the CPU percentage used and T_AVG_IO, T_AVG_CPU.

A second control method proposed by the exemplary embodiment is to multi-model and simultaneously control the relationships between system inputs (CPU percentage used, hit ratio) and system outputs (T_AVG_IO, T_AVG_CPU). In this case, the structure of the controller is as shown in FIG. 6. FIG. 6 is an example implementing the integrated time control unit 143.

The system 600 is represented as the relationships between the CPU percentage used 610 and the hit ratio 611, which are two system inputs, and T_AVG_IO 620 and T_AVG_CPU 621, which are two system outputs. For the system represented as multi-inputs and multi-outputs, the controller 630 simultaneously generates and controls the CPU percentage used and the hit ratio, which are two control signals. Since the system is modeled using multi-inputs/multi-outputs, the relationship between the input and the output is expressed by a determinant as the following Equation 1.

$$[ \begin{matrix}TARDY\_CPU ( t ) \\ TARDY\_IO ( t )\end{matrix} ] = A \times [ \begin{matrix}TARDY\_CUP ( t - 1 ) \\ TARDY\_IO ( t - 1 )\end{matrix} ] + B \times [ \begin{matrix}CPU percentage used ( t - 1 ) \\ Hit Ratio ( t - 1 )\end{matrix} ] \qquad [ Equation 1 ]$$

In equation 1, TARDY_CPU and TARDY_IO in a current control period t are expressed using TARDY_CPU and TARDY_IO at a preceding period t−1, and the CPU percentage used and the hit ratio, which are system input values. As described above, a model in which TARDY_CPU and TARDY_IO, which are current system state values, are dependent on only the states of preceding period t−1 that refers to a first-order system and the order of the system may be high in order to reflect an accurate model. The exemplary embodiment is not limited by the form and order of the model.

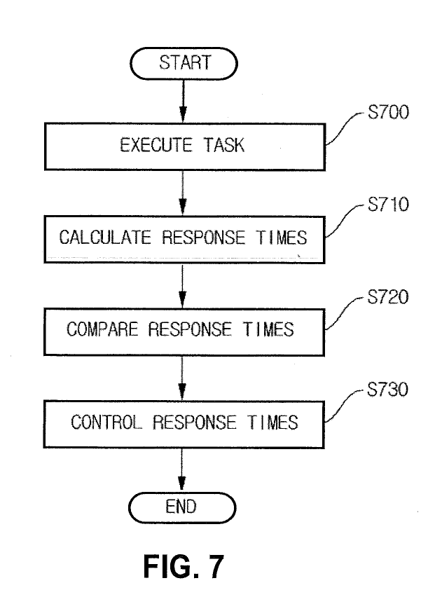

A method for controlling the response time of an application program in the apparatus 100 for controlling a response time is described below. FIG. 7 is a flow chart showing a method of controlling the response time of an application program according to a preferred embodiment of the present invention. The detailed description will be described with reference to FIG. 7.

Firstly, a task to process data is executed according to a predetermined first period (task execution step, S700).

In the exemplary embodiment, the step of executing the task 5700 may include a determination step, a data reception step and a data processing step when data is processed by accessing a storage medium. The determination step is a step of determining whether data to be processed is stored in a buffer related to the storage medium. The data reception step is a step of receiving the stored data from the buffer when the data is stored in the buffer, and receiving corresponding data from the storage medium through the buffer when the data is not stored in the buffer. The data processing step is a step of processing the received data. Meanwhile, the task execution step S700 may further include a buffer size alteration step. The buffer size alteration step is a step of altering the cache size of a buffer so as to satisfy a target hit ratio in response to a request from the response time control unit 140. In this case, the size of the buffer cache satisfying the target hit ratio is possible by maintaining a linear model or the like between two ratios. The exemplary embodiment is dependent on the model defining the relationship between the hit ratio and the size of the buffer cache and any model may be also used.

Thereafter, the response time of the task is calculated in consideration of a first time taken for the operation upon execution of the task and a second time taken for accessing the storage medium upon execution of the task (response time calculation step, S710). In the exemplary embodiment, considering that a second period is generally longer than a first period, the response time calculation step S710 calculates the mean value of first times and the mean value of second times whenever the second period is reached.

Thereafter, the calculated mean value of the response times is compared with a predefined target response time (response time comparison step, S720).

Subsequently, when the time difference between the compared two values is larger than a predetermined reference value, the response time of the tasks is controlled every predetermined second period (response time control step, S730).

The response time control step S730 assigns and modifies computer resources which enable the application program to be executed upon control of the response time. The response time control step S730 controls the response time of the tasks according to whether there is a correlation between the first time and the second time.

When there is no correlation between the first time and the second time, the response time control step S730 includes a first time control step and a second time control step. The first time control step is a step of controlling a first response time by forcing the mean value of the first times calculated in consideration of the CPU percentage used to be identical to the target first time. The second time control step is a step of controlling a second response time by forcing the mean value of the second times calculated in consideration of a probability that data to be processed is stored in a buffer related to the storage medium to be identical to a target second time, as a control step independently performed with respect to the step of controlling the first time. In the exemplary embodiment, the first time control step controls the first response time by modeling the relationship between the CPU percentage used and the calculated mean value of the first times and the second time control step controls the second response time by modeling the relationship between the ratio and the calculated mean value of the second times.

On the other hand, when there is a correlation between the first time and the second time, the response time control step S730 includes an integrated time control step. The integrated time control step is a step of controlling the first response time by forcing the mean value of the first times calculated in consideration of the CPU percentage used to be identical to the target first time, while simultaneously controlling the second response time by forcing the mean value of the second values calculated in consideration of the probability that data to be processed is stored in the buffer related to the storage medium to be identical to the target second time.

The method of controlling the response time of an application program according to the exemplary embodiment may further include a target response time definition step. The target response time definition step is a step of defining target response times separately for the first time and the second time. The target response time definition step may be performed before the task execution step S700. The target response time definition step may include a total time setting step, a statistic calculation step, a ratio calculation step and a target time definition step. The total time setting step is a step of setting a total time, which is the sum of the first time and the second time. The statistic calculation step is a step of calculating the statistic of the first times and the statistic of the second times by repeatedly performing the tasks. The ratio calculation step is a step of calculating a first ratio of the first time to the second time and a second ratio of the second time to the first time using the calculated statistic of the first times and the calculated statistic of the second times.

The target time definition step is a step of defining the target first time in consideration of the set total time and the first ratio and defining the target second time in consideration of the set total time and the second ratio. Meanwhile, the method of controlling the response time of an application program may further include a target response time re-definition step. The target response time re-definition step is a step of modifying and re-defining the target response time based on the result of control of the response times for tasks. The target response time re-definition step may be executed after the response time control step S730.

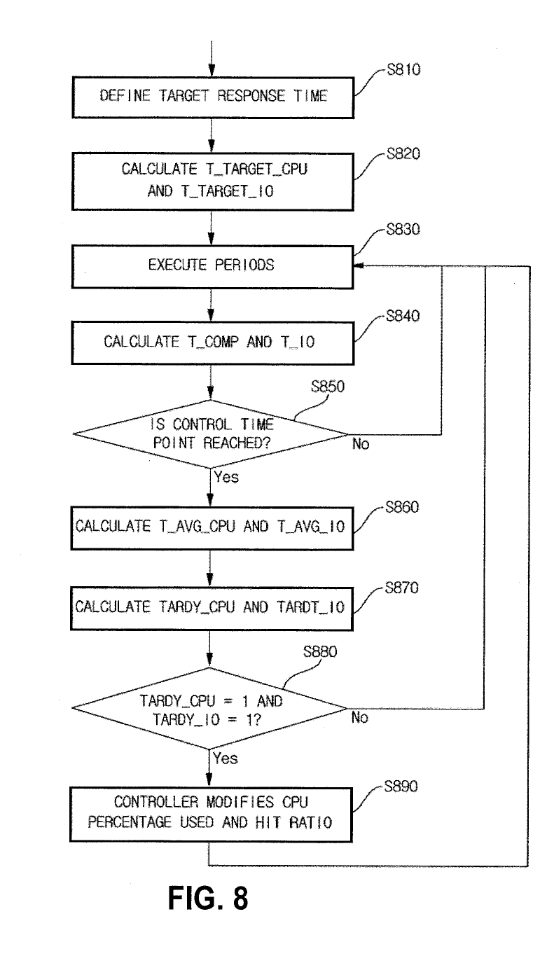

FIG. 8 is an embodiment of a procedure of controlling a response time using a multi-control method. The target response time 5810 defined by a user, T_TARGET is modified into T_TARGET_CPU and T_TARGET_IO through the above-described relationship equations (S820). Every execution period (S830), the total response time for current CPU operation, T_COMP and the total response time for accessing the storage device, T_IO are measured (S840). This period is repeated if it is not a control time point (S850). If it is the control time point, T_AVG_CPU and T_AVG_IO, which are the mean values within a period, are obtained (S860). Thereafter, TARDY_CPU and TARDY_IO are obtained (S870). If these values are not 1 (S880), the controller obtains the target response time by modifying the CPU percentage used and the hit ratio of the buffer cache (S890). Such a control period is repeated during the execution of the tasks.

The present invention may be applicable to a CPS (Cyber Physical Systems) for software (SW).

The spirit of the present invention has been just exemplified. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A method for controlling a response time of an application program, comprising:
a task execution step of executing a task of processing data according to a predetermined first period;
a response time calculation step of calculating a response time of the task in consideration of a first time taken for an operation upon execution of the task, and a second time taken for storage medium access upon execution of the task;
a response time comparison step of comparing a mean value of the calculated response times and a predefined target response time; and
a response time control step of controlling the response time of the task at every predetermined second period when a time difference between the compared two values is larger than the predetermined reference value.

2. The method of claim 1, wherein the response time control step modifies assigning of resources of a computer for executing the application program upon control of the response time.

3. The method of claim 1, wherein the second period is longer than the first period, and
the response time calculation step respectively calculates a mean value of the first times and a mean value of the second times whenever the second period is reached.

4. The method of claim 1, further comprising a target response time definition step of defining the target response time separately for the first time and the second time.

5. The method of claim 4, wherein the target response time definition step includes:
a total time setting step of setting a total time which is the sum of the first time and the second time;
a statistic calculation step of calculating a statistic of the first times and a statistic of the second times by repeatedly performing the tasks;
a ratio calculation step of calculating a first ratio of the first time to the second time and a second ratio of the second time to the first time using the calculated statistic of the first times and the calculated statistic of the second times; and
a target time definition step of defining the target first time in consideration of the set total time and the first ratio and defining the target second time in consideration of the set total time and the second ratio.

6. The method of claim 4, further comprising a target response time re-definition step of modifying and re-defining the target response time based on results of control of the response times for the tasks.

7. The method of claim 1, wherein the response time control step controls the response time of the task according to whether there is a correlation between the first time and the second time.

8. The method of claim 7, wherein, when there is no correlation between the first time and the second time, the response time control step includes:
a first time control step of controlling a first response time by forcing the mean value of the first times calculated in consideration of the CPU percentage used to be identical to the target first time; and
a second time control step of controlling a second response time by forcing the mean value of the second times calculated in consideration of a probability that data to be processed is stored in a buffer related to the storage medium to be identical to a target second time, as a control step independently performed with respect to the step of controlling the first time.

9. The method of claim 7, wherein, when there is a correlation between the first time and the second time, the response time control step includes an integrated time control step of controlling the first response time by forcing the mean value of the first times calculated in consideration of the CPU percentage used to be identical to the target first time, while simultaneously controlling the second response time by forcing the mean value of the second values calculated in consideration of the probability that data to be processed is stored in the buffer related to the storage medium to be identical to the target second time.

10. The method of claim 8, wherein the first time control step controls the first response time by modeling the relationship between the CPU percentage used and the calculated mean value of the first times, and
the second time control step controls the second response time by modeling the relationship between the ratio and the calculated mean value of the second times.

11. An apparatus for controlling a response time of an application program, comprising:
a task execution unit for executing a task of processing data according to a predetermined first period;
a response time calculation unit for calculating a response time of the task in consideration of a first time taken for operation upon execution of the task, and a second time taken for storage medium access upon execution of the task;
a response time comparison unit for comparing a mean value of the calculated response times and a predefined target response time; and
a response time control step for controlling the response time of the task at every predetermined second period when a time difference between the compared two values is larger than the predetermined reference value.

12. The apparatus of claim 11, wherein the response time control unit modifies assignment of resources of a computer for executing the application program upon control of the response time.

13. The apparatus of claim 11, wherein the second period is longer than the first period, and
the response time calculation unit respectively calculates a mean value of the first times and a mean value of the second times whenever the second period is reached.

14. The apparatus of claim 11, further comprising a target response time definition unit for defining the target response time separately for the first time and the second time.

15. The apparatus of claim 14, wherein the target response time definition unit includes:
a total time setting unit for setting a total time which is the sum of the first time and the second time;
a statistic calculation unit for calculating a statistic of the first times and a statistic of the second times by repeatedly performing the tasks;
a ratio calculation unit for calculating a first ratio of the first time to the second time and a second ratio of the second time to the first time using the calculated statistic of the first times and the calculated statistic of the second times; and
a target time definition unit for defining the target first time in consideration of the set total time and the first ratio and defining the target second time in consideration of the set total time and the second ratio.

16. The apparatus of claim 14, further comprising a target response time re-definition unit for modifying and re-defining the target response time based on results of controlling the response times for the tasks.

17. The apparatus of claim 11, wherein the response time control unit controls the response time of the task according to whether there is a correlation between the first time and the second time.

18. The apparatus of claim 17, wherein, when there is no correlation between the first time and the second time, the response time control unit includes:
a first time control unit for controlling a first response time by forcing the mean value of the first times calculated in consideration of the CPU percentage used to be identical to the target first time; and
a second time control unit for controlling a second response time by forcing the mean value of the second times calculated in consideration of a probability that data to be processed is stored in a buffer related to the storage medium to be identical to a target second time, as a control step independently performed with respect to the step of controlling the first time.

19. The apparatus of claim 17, wherein, when there is a correlation between the first time and the second time, the response time control unit includes an integrated time control unit for controlling the first response time by forcing the mean value of the first times calculated in consideration of the CPU percentage used to be identical to the target first time, while simultaneously controlling the second response time by forcing the mean value of the second values calculated in consideration of the probability that data to be processed is stored in the buffer related to the storage medium to be identical to the target second time.

20. The apparatus of claim 18, wherein the first time control unit controls the first response time by modeling the relationship between the CPU percentage used and the calculated mean value of the first times, and
the second time control unit controls the second response time by modeling the relationship between the ratio and the calculated mean value of the second times.
